(19) United States
(12) Patent Application Publication
(10) Pub. No.: US 2026/0042903 A1
(43) Pub. Date: Feb. 12, 2026

(54) Laser Transmissive Polyarylene Sulfide Composition

(71) Applicant: Ticona LLC, Florence, KY (US)

(72) Inventors: Wenqi Li, Shanghai (CN); Yuehua Yu, Cincinnati, OH (US); Fangfang Tao, Shanghai (CN)

(21) Appl. No.: 19/263,580

(22) Filed: Jul. 9, 2025

Related U.S. Application Data
(60) Provisional application No. 63/679,773, filed on Aug. 6, 2024.

(51) Int. Cl. C08K 5/527; B32B 7/027; B32B 27/08; B32B 27/20; B32B 27/28; C08J 5/12; C08K 5/544; C08K 9/06

(52) U.S. Cl. CPC C08K 5/527; B32B 7/027; B32B 27/08; B32B 27/20; B32B 27/286; C08J 5/121; C08K 5/544; C08K 9/06; B32B 2250/02; B32B 2250/24; B32B 2262/101; B32B 2262/16; B32B 2307/30; B32B 2307/54; B32B 2307/546; C08J 2381/04; C08K 2201/003; C08K 2201/004; C08K 2201/014

(57) ABSTRACT

A polymer composition that comprising 100 parts by weight of a polymer matrix that contains a polyarylene sulfide, from about 10 parts by weight to about 80 parts by weight of inorganic fibers having an aspect ratio of from about 1.5 to about 10, and from about 0.15 parts to about 2.5 parts by weight of antioxidants is provided. The polymer composition exhibits a crystallization half-time of about 8.5 minutes or more as determined by differential scanning calorimetry at an isothermal hold temperature of 245° C. in accordance with ISO 11357-7:2022.

### RELATED APPLICATION

The present application is based upon and claims priority to U.S. Provisional Patent Application Ser. No. 63/679,773, having a filing date of Aug. 6, 2024, which is incorporated herein by reference.

### BACKGROUND OF THE INVENTION

Electric vehicles, such as battery-electric vehicles, plug-in hybrid-electric vehicles, mild hybrid-electric vehicles, or full hybrid-electric vehicles generally have an electric powertrain that contains an electric propulsion source (e.g., battery) and a transmission. High performance polymeric materials are often employed in the electric vehicle for various components, such as in high voltage connectors, power converter housings, battery assembly housings, fluid pumps, inverters, busbars, twisted cables, individual sense lead wires, wire crimps, grommet moldings, quick connectors, tees, interconnects, guide rails, sealing rings (e.g., brushless direct current sealing rings, battery cell sealing rings, etc.), etc. Many of these components are formed by laser welding together two or more different molded polymer parts at a polymer-to-polymer joint interface. To facilitate such a laser welding process, at least one of the components is generally transmissive to the laser at a certain wavelength. Unfortunately, attempts at increasing laser transmissivity often adversely impacts other properties of the polymeric material, such as mechanical properties, thermal properties, flowability, etc. Conversely, polymeric materials that are capable of achieving a combination of good mechanical and thermal properties, as well as a high degree of flowability, also tend to not be laser transmissive enough to yield a high quality weld joint. As such, a need currently exists for laser transmissive polymer compositions that can exhibit other good properties for use in various applications, such as electric vehicle components.

### SUMMARY OF THE INVENTION

In accordance with one embodiment of the present invention, a laser transmissive polymer composition is disclosed that comprises 100 parts by weight of a polymer matrix that contains a polyarylene sulfide, from about 10 parts by weight to about 80 parts by weight of inorganic fibers having an aspect ratio of from about 1.5 to about 10, and from about 0.15 parts to about 2.5 parts by weight of antioxidants. The polymer composition exhibits a crystallization half-time of about 8.5 minutes or more as determined by differential scanning calorimetry at an isothermal hold temperature of 245° C. in accordance with ISO 11357-7:2022.

In accordance with another embodiment of the present invention, a composite structure is disclosed that comprises a first polymer component that is laser welded to a second polymer component at a polymer-polymer interface. The first polymer component includes a polymer composition, such as described herein.

In accordance with yet another embodiment of the present invention, a method of joining a first polymer component to a second polymer component is disclosed. The method comprises contacting a first polymer component and a second polymer component to form an interface. The first polymer component comprises a polymer composition, such as described herein, and passing a light beam through a portion of the first polymer component to form a laser weld joint at the interface.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 illustrates an electric vehicle including components that may incorporate a polymer composition as disclosed herein;

FIG. 2 illustrates one embodiment of a busbar as may incorporate a polymer composition as disclosed herein;

FIG. 3 illustrates a battery assembly that may employ components that may incorporate a polymer composition as disclosed herein;

FIG. 4 illustrates an electronic system as may include components that may incorporate a polymer composition as disclosed herein;

FIG. 5 illustrates a current sensor as may be included in an electronic system as in FIG. 4;

FIG. 6 illustrates an inverter system as may be present in an electric car including components that may incorporate a polymer composition as disclosed herein;

FIG. 7 is a perspective view of one embodiment of a connector that may incorporate a polymer composition as disclosed herein;

FIG. 8 is a plan view of the connector of FIG. 7 in which the first and second connector portions are disengaged;

FIG. 9 is a plan view of the connector of FIG. 7 in which the first and second connector portions are engaged;

FIG. 10 illustrates examples of components that may incorporate a polymer composition as disclosed herein;

FIG. 11 illustrates additional components that may incorporate a polymer composition as disclosed herein;

FIG. 12 illustrates a low temperature thermal loop as may include components that may incorporate a polymer composition as disclosed herein;

FIG. 13 illustrates a high temperature thermal loop as may include components that may incorporate a polymer composition as disclosed herein; and

FIG. 14 illustrates one embodiment of a water pump as may incorporate a polymer composition as disclosed herein.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a laser transmissive polymer composition that may contain inorganic fibers, antioxidant, and other optional ingredients dispersed within a polymer matrix that includes a polyarylene sulfide. More particularly, through selective control over the particular nature and concentration of these components, the present inventors have discovered that the resulting polymer composition can achieve a unique combination of properties in that it is laser transmissive but also exhibit a certain crystallization rate to facilitate the formation of a high quality weld during a laser welding process. More particularly, the polymer composition typically exhibits a crystallization half-time of about 8.5 minutes or more, in some embodiments about 10 minutes or more, in some embodiments about 12 minutes or more, and in some embodiments, from about 13 to about 20 minutes, as determined by differential scanning calorimetry at an isothermal hold temperature of 245° C. in accordance with ISO 11357-7:2022. The composition also typically exhibits a laser transmission rate of from about 10% to about 40%, in some embodiments from about 11% to about 30%, and in some embodiments, from about 12% to about 25%, as determined at a thickness of 1 mm and wavelength of 980 nm.

While exhibiting good crystallization and laser transmission properties, the polymer composition may nevertheless achieve a relative high degree of strength and rigidity. For example, the polymer composition may exhibit a Charpy notched impact strength of about 4 kJ/m² or more, such as in some embodiments from about 5 to about 20 kJ/m², and in some embodiments, from about 8 to about 15 kJ/m², as determined at a temperature of 23° C. in accordance with ISO 179-1:2010. The polymer composition may also exhibit a tensile stress at break of about 100 MPa or more, in some embodiments from about 130 MPa to about 350 MPa, and in some embodiments, from about 160 to about 300 MPa; a tensile break strain of about 1% or more, in some embodiments from about 1.5% to about 5%; and/or a tensile modulus of about 8,000 MPa or more, in some embodiments from about 9,000 MPa to about 25,000 MPa, in some embodiments from about 10,000 MPa to about 20,000 MPa. The tensile properties may be determined in accordance with ISO 527:2019 at a temperature of 23° C. The composition may also exhibit a flexural strength of about 100 MPa or more, in some embodiments from about 150 to about 400 MPa, and in some embodiments from about 200 to about 350 MPa, a flexural break strain of about 1% or more, in some embodiments from about 1.5% to about 5%; and/or a flexural modulus of 8,000 MPa or more, in some embodiments from about 9,000 MPa to about 25,000 MPa, and in some embodiments, from about 10,000 MPa to about 20,000 MPa. The flexural properties may be determined in accordance with ISO 178:2019 at a temperature of 23° C.

While exhibiting the properties noted above, the composition may still exhibit good flow properties as reflected by a relatively low melt viscosity. For example, the polymer composition may exhibit a melt viscosity of about 500 Pa-s or less, in some embodiments about 450 Pa-s or less, in some embodiments from about 10 to about 400 Pa-s, and in some embodiments, from about 50 to about 375 Pa-s, as determined in accordance with ISO 11443:2021 at a temperature of about 310° C. and at a shear rate of 400 s⁻¹.

Various embodiments of the present invention will now be described in greater detail below.

### I. Polymer Composition

### A. Polymer Matrix

The polymer matrix typically constitutes from about 40 wt. % to about 85 wt. %, in some embodiments from about 50 wt. % to about 80 wt. %, and in some embodiments, from about 55 wt. % to about 75 wt. % of the polymer composition. The polymer matrix generally contains at least one polyarylene sulfide. For example, polyarylene sulfides typically constitute from about 50 wt. % to 100 wt. %, in some embodiments from about 70 wt. % to 100 wt. %, and in some embodiments, from about 90 wt. % to 100 wt. % of the polymer matrix (e.g., 100 wt. %).

The polyarylene sulfide may be homopolymers or copolymers. For instance, selective combination of dihaloaromatic compounds can result in a polyarylene sulfide copolymer containing not less than two different units. For instance, when p-dichlorobenzene is used in combination with m-dichlorobenzene or 4,4′-dichlorodiphenylsulfone, a polyarylene sulfide copolymer can be formed containing segments having the structure of formula:

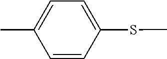

and segments having the structure of formula:

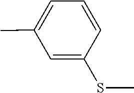

or segments having the structure of formula:

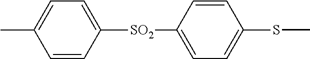

The polyarylene sulfide may be linear, semi-linear, branched, or crosslinked. Linear polyarylene sulfides typically contain 80 mol % or more of the repeating unit —(Ar—S)—. Such linear polymers may also include a small amount of a branching unit or a cross-linking unit, but the amount of branching or cross-linking units is typically less than about 1 mol % of the total monomer units of the polyarylene sulfide. A linear polyarylene sulfide polymer may be a random copolymer or a block copolymer containing the above-mentioned repeating unit. Semi-linear polyarylene sulfides may likewise have a cross-linking structure or a branched structure introduced into the polymer a small amount of one or more monomers having three or more reactive functional groups. By way of example, monomer components used in forming a semi-linear polyarylene sulfide can include an amount of polyhaloaromatic compounds having two or more halogen substituents per molecule which can be utilized in preparing branched polymers. Such monomers can be represented by the formula R′Xₙ, where each X is selected from chlorine, bromine, and iodine, n is an integer of 3 to 6, and R′ is a polyvalent aromatic radical of valence n which can have up to about 4 methyl substituents, the total number of carbon atoms in R′ being within the range of 6 to about 16. Examples of some polyhaloaromatic compounds having more than two halogens substituted per molecule that can be employed in forming a semi-linear polyarylene sulfide include 1,2,3-trichlorobenzene, 1,2,4-trichlorobenzene, 1,3-dichloro-5-bromobenzene, 1,2,4-triiodobenzene, 1,2,3,5-tetrabromobenzene, hexachlorobenzene, 1,3,5-trichloro-2,4,6-trimethylbenzene, 2,2′,4,4′-tetrachlorobiphenyl, 2,2′,5,5′-tetra-iodobiphenyl, 2,2′,6,6′-tetrabromo-3,3′,5,5′-tetramethylbiphenyl, 1,2,3,4-tetrachloronaphthalene, 1,2,4-tribromo-6-methylnaphthalene, etc., and mixtures thereof.

If desired, the polyarylene sulfide can be functionalized. For instance, a disulfide compound containing reactive functional groups (e.g., carboxyl, hydroxyl, amine, etc.) can be reacted with the polyarylene sulfide. Functionalization of the polyarylene sulfide can further provide sites for bonding between any impact modifiers and the polyarylene sulfide, which can improve distribution of the impact modifier throughout the polyarylene sulfide and prevent phase separation. The disulfide compound may undergo a chain scission reaction with the polyarylene sulfide during melt processing to lower its overall melt viscosity. When employed, disulfide compounds typically constitute from about 0.01 wt. % to about 3 wt. %, in some embodiments from about 0.02 wt. % to about 1 wt. %, and in some embodiments, from about 0.05 to about 0.5 wt. % of the polymer composition. The ratio of the amount of the polyarylene sulfide to the amount of the disulfide compound may likewise be from about 1000:1 to about 10:1, from about 500:1 to about 20:1, or from about 400:1 to about 30:1. Suitable disulfide compounds are typically those having the following formula:

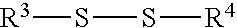

wherein R³ and R⁴ may be the same or different and are hydrocarbon groups that independently include from 1 to about 20 carbons. For instance, R³ and R⁴ may be an alkyl, cycloalkyl, aryl, or heterocyclic group. In certain embodiments, R³ and R⁴ are generally nonreactive functionalities, such as phenyl, naphthyl, ethyl, methyl, propyl, etc. Examples of such compounds include diphenyl disulfide, naphthyl disulfide, dimethyl disulfide, diethyl disulfide, and dipropyl disulfide. R³ and R⁴ may also include reactive functionality at terminal end(s) of the disulfide compound. For example, at least one of R³ and R⁴ may include a terminal carboxyl group, hydroxyl group, a substituted or non-substituted amino group, a nitro group, or the like. Examples of compounds may include, without limitation, 2,2′-diaminodiphenyl disulfide, 3,3′-diaminodiphenyl disulfide, 4,4′-diaminodiphenyl disulfide, dibenzyl disulfide, dithiosalicylic acid (or 2,2′-dithiobenzoic acid), dithioglycolic acid, α,α′-dithiodilactic acid, β,β′-dithiodilactic acid, 3,3′-dithiodipyridine, 4,4′dithiomorpholine, 2,2′-dithiobis(benzothiazole), 2,2′-dithiobis(benzimidazole), 2,2′-dithiobis(benzoxazole), 2-(4′-morpholinodithio)benzothiazole, etc., as well as mixtures thereof.

The polymer matrix may exhibit a melt flow index of greater than about 250 grams per 10 minutes, in some embodiments greater than about 300 grams per 10 minutes, and in some embodiments, from about 350 to about 900 grams per 10 minutes, as determined in accordance with ASTM D1238-13 at a load of 2.16 kg and temperature of 190° C. The target melt flow index may be achieved through the use of a single polyarylene sulfide or through the use of a blend of polyarylene sulfides having different melt flow indices. In one embodiment, for example, the polymer matrix may employ a first polyarylene sulfide having a first melt flow index and a second polyarylene sulfide having a second melt flow index. The ratio of the first melt flow index to the second melt flow index may, for example, be from about 1.5 to about 4, in some embodiments from about 1.8 to about 3.2, and in some embodiments, from about 2 to about 3. The first melt flow index may, for example, range from about 300 to about 700, in some embodiments from about 350 to about 650, and in some embodiments, from about 400 to about 600 grams per 10 minutes. Likewise, the second melt flow index may range from about 50 to about 300, in some embodiments from about 100 to about 250, and in some embodiments, from about 120 to about 220 grams per 10 minutes. Depending on the exact melt flow indices chosen, the relative weight percentage of each polymer may thus be selectively controlled to achieve the target melt flow index for the polymer matrix. Typically, for example, the first polyarylene sulfide and the second polyarylene sulfide each constitutes from about 30 wt. % to about 70 wt. %, in some embodiments from about 35 wt. % to about 65 wt. %, and in some embodiments, from about 40 wt. % to about 60 wt. % of the polymer matrix.

### B. Inorganic Fibers

As noted above, the polymer composition may also contain inorganic fibers, such as in an amount of from about 10 parts to about 80 parts by weight, in some embodiments from about 20 parts to about 70 parts by weight, and in some embodiments, from about 25 parts to about 50 parts by weight per 100 parts by weight of the polymer matrix. The inorganic fibers may, for instance, constitute from about 10 wt. % to about 60 wt. %, in some embodiments from about 20 wt. % to about 50 wt. %, and in some embodiments, from about 25 wt. % to about 45 wt. % of the polymer composition.

Suitable inorganic fibers may include those derived from glass; titanates (e.g., potassium titanate); silicates, such as neosilicates, sorosilicates, inosilicates (e.g., calcium inosilicates, such as wollastonite; calcium magnesium inosilicates, such as tremolite; calcium magnesium iron inosilicates, such as actinolite; magnesium iron inosilicates, such as anthophyllite; etc.), phyllosilicates (e.g., aluminum phyllosilicates, such as palygorskite), tectosilicates, etc.; sulfates, such as calcium sulfates (e.g., dehydrated or anhydrous gypsum); mineral wools (e.g., rock or slag wool); and so forth. Glass fibers may be particularly suitable, such as those formed from E-glass, A-glass, C-glass, D-glass, AR-glass, R-glass, S1-glass, S2-glass, etc., as well as mixtures thereof. Regardless of the particular type selected, it is generally desired that the fibers have a relatively high index of refraction to help improve the laser transmission rate. For example, the index of refraction is typically from about 1.5 to about 2.2, in some embodiments from about 1.55 to about 2, and in some embodiments, from about 1.6 to about 1.9, as determined at a wavelength of 590 nm.

To help further improve the quality of the laser weld, it may also be desired to employ inorganic fibers that have a relatively flat cross-sectional dimension in that they have an aspect ratio of from about 1.5 to about 10, in some embodiments from about 2 to about 8, and in some embodiments, from about 3 to about 5. The aspect ratio is determined by dividing the cross-sectional width of the fibers (i.e., in the direction of the major axis) by the cross-sectional thickness of the fibers (i.e., in the direction of the minor axis). The shape of such fibers may be in the form of an ellipse, rectangle, rectangle with one or more rounded corners, etc. The cross-sectional width of the fibers may be from about 1 to about 50 micrometers, in some embodiments from about 5 to about 45 micrometers, and in some embodiments, from about 10 to about 35 micrometers. The fibers may also have a thickness of from about 0.5 to about 30 micrometers, in some embodiments from about 1 to about 20 micrometers, and in some embodiments, from about 3 to about 15 micrometers. It should be understood that the cross-sectional thickness and/or width need not be uniform over the entire cross-section. In such circumstances, the cross-sectional width is considered as the largest dimension along the major axis of the fiber and the cross-sectional thickness is considered as the largest dimension along the minor axis. For example, the cross-sectional thickness for an elliptical fiber is the minor diameter of the ellipse.

The inorganic fibers may also have a narrow size distribution. That is, at least about 60% by volume of the fibers, in some embodiments at least about 70% by volume of the fibers, and in some embodiments, at least about 80% by volume of the fibers may have a width and/or thickness within the ranges noted above. The fibers may be endless or chopped fibers, such as those having a length of from about 1 to about 15 millimeters, and in some embodiments, from about 2 to about 6 millimeters. The dimension of the fibers (e.g., length, width, and thickness) may be determined using known optical microscopy techniques.

If desired, the inorganic fibers may contain a sizing composition coated thereon to help further enhance the ability of the composition used in a laser welding process. The sizing composition may include an organosilane compound that is capable of forming Si—O—Si covalent bonds between the glass fiber surface and silanols obtained by hydrolysis of the silane compound, as well as between adjacent silanol groups. The resulting covalent bonds forms a crosslinked structure at the surface of the fibers that can the properties of the fibers. Such organosilane compounds may, for instance, constitute from about 2 wt. % to about 40 wt. %, in some embodiments from about 2.5 wt. % to about 20 wt. %, and in some embodiments, from about 5 wt. to about 15 wt. % of the solids content of the sizing composition (i.e., excluding water). The organosilane compound may, for example, be any alkoxysilane as is known in the art, such as vinlyalkoxysilanes, epoxyalkoxysilanes, aminoalkoxysilanes, mercaptoalkoxysilanes, and combinations thereof. In one embodiment, for instance, the organosilane compound may have the following general formula:

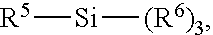

wherein,
R⁵ is a sulfide group (e.g., —SH), an alkyl sulfide containing from 1 to 10 carbon atoms (e.g., mercaptopropyl, mercaptoethyl, mercaptobutyl, etc.), alkenyl sulfide containing from 2 to 10 carbon atoms, alkynyl sulfide containing from 2 to 10 carbon atoms, amino group (e.g., NH₂), aminoalkyl containing from 1 to 10 carbon atoms (e.g., aminomethyl, aminoethyl, aminopropyl, aminobutyl, etc.); aminoalkenyl containing from 2 to 10 carbon atoms, aminoalkynyl containing from 2 to 10 carbon atoms, and so forth;
R⁶ is an alkoxy group of from 1 to 10 carbon atoms, such as methoxy, ethoxy, propoxy, and so forth.

Aminosilane compounds are particularly suitable and may include monomeric or oligomeric (<6 units) silanes. Aminotrialkoxysilanes may be employed in certain embodiments to form a three dimensional network of Si—O—Si covalent bonds at the surface and around the surface of the fibers. Aminodialkoxysilanes may likewise be employed in certain embodiments to form a hairlike structure on the surface of the fibers. While not necessarily forming a three-dimensional crosslinked protective sheath around the fibers, the dialkoxysilanes may nevertheless facilitate impregnation of the fiber bundles and wetting of the individual fibers by a polymer melt. Thus, it may be desirable to employ trialkoxysilanes, dialkoxysilanes, or mixtures thereof in the sizing composition. Specific examples of suitable aminosilanes may include, for instance, aminodialkoxysilanes, such as γ-aminopropylmethyldiethoxysilane, N-β-(Aminoethyl)-gamma-aminopropylmethyldimethoxysilane, N-β-(Aminoethyl)-γ-aminopropyl-methyldimethoxysilane, N-β-(Aminoethyl)-γ-aminoisobutylmethyldimethoxy-silane, γ-aminopropylmethyldimethoxysilane, N-β-(Aminoethyl)-γ-aminopropyl-methyldiethoxysilane, etc.; aminotrialkoxysilanes, such as γ-aminopropyltriethoxysilane, γ-aminopropyltri-methoxysilane, N-β-(Aminoethyl)-γ-aminopropyl-trimethoxysilane, N-β-(Aminoethyl)-γ-aminopropyltriethoxysilane, diethylene-triaminopropyltrimethoxysilane, Bis-(γ-trimethoxysilylpropyl) amine, N-phenyl-γ-aminopropyltrimethoxysilane, γ-amino-3,3-dimethylbutyltrimethoxysilane, γ-aminobutyltriethoxysilane, etc.; as well as mixtures of any of the foregoing.

### C. Antioxidant

In addition to the components noted above, the polymer composition may generally contain one or more antioxidants. While the exact mechanism is not fully understood, the present inventors have discovered that the use of an antioxidant can help achieve the desired crystallization properties without adversely the laser transmission rate, mechanical properties, and/or thermal properties of the polymer composition. To help achieve a desired balance between these properties, it is typically desired to use a certain minimum amount of antioxidant(s) to achieve the desired crystallization target, but not so great of an amount that the melt viscosity is increased to such a large extent that flowability becomes impacted. In this regard, antioxidants are typically present in an amount of from about 0.15 parts to about 2.5 parts by weight, in some embodiments from about 0.2 to about 1.5 parts by weight, in some embodiments from about 0.25 to about 1 part by weight, and in some embodiments, from about 0.3 to about 0.8 part by weight per 100 parts by weight of the polymer matrix. For example, antioxidants may constitute from about 0.05 wt. % to about 2 wt. %, in some embodiments from about 0.1 wt. % to about 1.5 wt. %, in some embodiments from about 0.2 wt. % to about 1 wt. %, and in some embodiments, from about 0.3 wt. % to about 0.8 wt. % of the polymer composition.

Any of a variety of antioxidants may generally be employed, such as sterically hindered phenolic antioxidants, phosphorous-based antioxidants, etc. In one particular embodiment, for example, a phosphorous-based antioxidant, such as a phosphite antioxidant, may be employed. When employed, for example, the phosphite antioxidant may include a variety of different compounds, such as aryl monophosphites, aryl disphosphites, etc., as well as mixtures thereof. For example, an aryl diphosphite may be employed that has the following general structure (I):

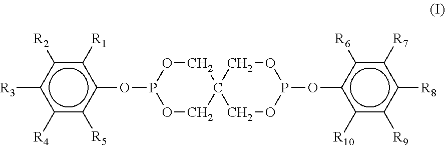

wherein,
R₁, R₂, R₃, R₄, R₅, R₆, R₇, R₈, R₉, and R₁₀ are independently selected from hydrogen, C₁ to C₁₀ alkyl, and C₃ to C₃₀ branched alkyl, such as methyl, ethyl, propyl, isopropyl, butyl, or tertiary butyl moieties.

Examples of such aryl diphosphite compounds include, for instance, bis(2,4-dicumylphenyl)pentaerythritol diphosphite (commercially available as Doverphos® S-9228) and bis(2,4-di-t-butylphenyl)pentaerythritol diphosphite (commercially available as Ultranox® 626). Likewise, suitable aryl monophosphites may include tris(2,4-di-tert-butylphenyl)phosphite (commercially available as Irgafos® 168); bis(2,4-di-tert-butyl-6-methylphenyl) ethyl phosphite (commercially available as Irgafos® 38); and so forth.

### D. Optional Components

In addition to the components noted above, the polymer composition may also contain a variety of other optional components to help improve its overall properties. Examples of such components may include, for instance, colorants (e.g., black colorants), stabilizers (e.g., heat stabilizers, UV stabilizers, etc.), coupling agents, impact modifiers, crosslinking agents, surfactants, waxes, flow promoters, solid solvents, and other materials added to enhance properties and processability.

In one embodiment, for example, an organosilane coupling agent may also be employed in the polymer composition, such as in an amount of from about 0.1 to about 3 parts by weight, in some embodiments from about 0.15 to about 1.5 parts by weight, and in some embodiments, from about 0.2 to about 0.8 parts by weight per 100 parts by weight of the polymer matrix. For example, organosilane compounds can constitute from about 0.05 wt. % to about 2 wt. %, in some embodiments from about 0.1 wt. % to about 1.5 wt. %, and in some embodiments, from about 0.2 to about 0.8 wt. % of the polymer composition. The organosilane coupling agent may, for example, be an alkoxysilane such as those having the general formula of the organosilanes referenced above. Particularly suitable organosilane coupling agents are 3-aminopropyltriethoxysilane and 3-mercaptopropyltrimethoxysilane.

Colorants (e.g., organic dyes) may also be employed in certain embodiments of the present invention. For example, the polymer composition may contain a black colorant. To help ensure that the polymer composition can achieve the desired laser transmission rate, it is typically desired that the colorant has a degree of light transmittance of at least about 20% at a wavelength within the range 800 nm to 1 mm. Examples of suitable colorants for this purpose may include, for instance, organic dyes that are anthracene-based, anthraquinone-based, perylene-based, perinone-based, heterocycle-based, disazo-based, monoazo-based, or combinations thereof. When employed, colorants typically constitute from about 0.1 to about 10 parts by weight, in some embodiments from about 0.2 to about 8 parts by weight, and in some embodiments, from about 0.5 to about 5 parts by weight per 100 parts by weight of the polymer matrix. For example, colorants may constitute from about 0.1 wt. % to about 5 wt. %, in some embodiments from about 0.2 wt. % to about 4 wt. %, and in some embodiments, from about 0.4 to about 2 wt. % of the polymer composition.

### II. Melt Processing

The manner in which the polyarylene sulfide(s), inorganic fibers, antioxidant(s), and various other optional additives are combined may vary as is known in the art. For instance, the materials may be supplied either simultaneously or in sequence to a melt processing device that dispersively blends the materials. Batch and/or continuous melt processing techniques may be employed. For example, a mixer/kneader, Banbury mixer, Farrel continuous mixer, single-screw extruder, twin-screw extruder, roll mill, etc., may be utilized to blend and melt process the materials. One particularly suitable melt processing device is a co-rotating, twin-screw extruder (e.g., Leistritz co-rotating fully intermeshing twin screw extruder). Such extruders may include feeding and venting ports and provide high intensity distributive and dispersive mixing. For example, the components may be fed to the same or different feeding ports of a twin-screw extruder and melt blended to form a substantially homogeneous melted mixture. Melt blending may occur under high shear/pressure and heat to ensure sufficient dispersion. For example, melt processing may occur at a temperature of from about 100° C. to about 500° C., and in some embodiments, from about 150° C. to about 300° C. Likewise, the apparent shear rate during melt processing may range from about 100 seconds⁻¹ to about 10,000 seconds⁻¹, and in some embodiments, from about 500 seconds⁻¹ to about 1,500 seconds⁻¹. Of course, other variables, such as the residence time during melt processing, which is inversely proportional to throughput rate, may also be controlled to achieve the desired degree of homogeneity.

If desired, one or more distributive and/or dispersive mixing elements may be employed within the mixing section of the melt processing unit. Suitable distributive mixers may include, for instance, Saxon, Dulmage, Cavity Transfer mixers, etc. Likewise, suitable dispersive mixers may include Blister ring, Leroy/Maddock, CRD mixers, etc. As is well known in the art, the mixing may be further increased in aggressiveness by using pins in the barrel that create a folding and reorientation of the polymer melt, such as those used in Buss Kneader extruders, Cavity Transfer mixers, and Vortex Intermeshing Pin mixers. The speed of the screw can also be controlled to improve the characteristics of the composition. For instance, the screw speed can be about 400 rpm or less, in one embodiment, such as between about 200 rpm and about 350 rpm, or between about 225 rpm and about 325 rpm. In one embodiment, the compounding conditions can be balanced so as to provide a polymer composition that exhibits improved properties. For example, the compounding conditions can include a screw design to provide mild, medium, or aggressive screw conditions. For example, system can have a mildly aggressive screw design in which the screw has one single melting section on the downstream half of the screw aimed towards gentle melting and distributive melt homogenization. A medium aggressive screw design can have a stronger melting section upstream from the filler feed barrel focused more on stronger dispersive elements to achieve uniform melting. Additionally, it can have another gentle mixing section downstream to mix the fillers. This section, although weaker, can still add to the shear intensity of the screw to make it stronger overall than the mildly aggressive design. A highly aggressive screw design can have the strongest shear intensity of the three. The main melting section can be composed of a long array of highly dispersive kneading blocks. The downstream mixing section can utilize a mix of distributive and intensive dispersive elements to achieve uniform dispersion of all type of fillers. The shear intensity of the highly aggressive screw design can be significantly higher than the other two designs. In one embodiment, a system can include a medium to aggressive screw design with relatively mild screw speeds (e.g., between about 200 rpm and about 300 rpm).

### III. Shaped Part

A shaped part may be formed from the polymer composition using a variety of different techniques. Suitable techniques may include, for instance, injection molding, low-pressure injection molding, extrusion compression molding, gas injection molding, foam injection molding, low-pressure gas injection molding, low-pressure foam injection molding, gas extrusion compression molding, foam extrusion compression molding, extrusion molding, foam extrusion molding, compression molding, foam compression molding, gas compression molding, etc. For example, an injection molding system may be employed that includes a mold within which the polymer composition may be injected. The time inside the injector may be controlled and optimized so that polymer matrix is not pre-solidified. When the cycle time is reached and the barrel is full for discharge, a piston may be used to inject the composition to the mold cavity. Compression molding systems may also be employed. As with injection molding, the shaping of the polymer composition into the desired article also occurs within a mold. The composition may be placed into the compression mold using any known technique, such as by being picked up by an automated robot arm. The temperature of the mold may be maintained at or above the solidification temperature of the polymer composition for a desired time period to allow for solidification. The molded product may then be solidified by bringing it to a temperature below that of the melting temperature. The resulting product may be de-molded. The cycle time for each molding process may be adjusted to suit the polymer composition, to achieve sufficient bonding, and to enhance overall process productivity.

### IV. Laser Welding

As indicated above, the unique properties of the polymer composition can more readily allow it to be laser welded to another component (e.g., polymeric component) to form a composite structure. Laser welding typically involves the use of an infrared light beam to create an adhesive joint between two polymer compositions. In laser welding, a first polymer component and a second polymer component are contacted to form an interface between the two polymer components (“polymer-polymer interface”). The first polymer component, which may be formed from the polymer composition of the present in invention, is generally transparent to the light beam, and the second polymer component may be less transparent than the first component and can absorb the light beam. For example, the first polymer component (and polymer composition used to form the component) may exhibit a laser transmission rate of from about 10% to about 40%, in some embodiments from about 11% to about 30%, and in some embodiments, from about 12% to about 25%, as determined at a thickness of 1 mm and wavelength of 980 nm. Conversely, the second polymer component (and polymer composition used to form the component) may exhibit a laser transmission rate that is lower than the first polymer component, such as about 10% at a thickness of 1 mm and wavelength of 980 nm. Regardless, the polymer-polymer interface is irradiated with the light beam by passing the light beam through a portion of the first polymer component. Of course, it should also be understood that the infrared light beam can alternatively be passed through the second polymer component prior to irradiating the polymer-polymer interface. Regardless, at the polymer-polymer interface, the second polymer component may absorb the light and converts the infrared radiation into heat. The generated heat melts the second polymer component at the location where it is contacted by the light. Additionally, the generated heat is also conducted from the second polymer component to the first polymer component and melts a portion of the first polymer component. Ultimately a melt, including the first polymer component and the second polymer component, is formed. When the light source is subsequently moved (or removed), the melt cools and forms a solid adhesive joint including a blend of the first and second polymer components.

The particular nature of the polymer component used to form the second polymer component is not particularly limited. For example, the polymer composition used to form the second polymer component may have a similar melting temperature to the polymer composition used to form the first polymer composition and, preferably, less than or equal to the melting point. For example, the polymer composition used to form the first polymer component, which may be the polymer composition of the present invention, may have a melting temperature of from about 250° C. to about 320° C., and in some embodiments, from about 270° C. to about 300° C., while the polymer composition used to form the second polymer component may have a melting temperature of from about 200° C. to about 300° C., and in some embodiments, from about 220° C. to about 270° C. Suitable polymers for forming the second polymer component may, for example, include acrylonitrile butadiene styrene, polyamide, polybutylene terephthalate, polycarbonate, polyethylene (high density and low density), poly(ether ether ketone), poly(ether sulfone), polyoxymethylene, polytetrafluoroethylene, thermoplastic elastomers, as well as combinations thereof.

### V. Electrical Vehicle

As previously mentioned, the polymer composition, shaped part, and/or laser welded composite structure are particularly beneficial for use in components of an electric vehicle, such as a battery-powered electric vehicle, fuel cell-powered electric vehicle, plug-in hybrid-electric vehicle (PHEV), mild hybrid-electric vehicle (MHEV), full hybrid-electric vehicle (FHEV), etc. Referring to FIG. 1, for instance, one embodiment of an electric vehicle 112 that includes a powertrain 110 is shown. The powertrain 110 contains one or more electric machines 114 connected to a transmission 116, which in turn is mechanically connected to a drive shaft 120 and drive wheels 122. Although by no means required, the transmission 116 in this particular embodiment is also connected to an engine 118, though the description herein is equally applicable to a pure electric vehicle. The electric machines 114 may be capable of operating as a motor or a generator to provide propulsion and deceleration capability. The powertrain 110 also includes a propulsion source, such as a battery assembly 124, which stores and provides energy for use by the electric machines 114. The battery assembly 124 typically provides a high voltage current output (e.g., DC current at a voltage of from about 400 volts to about 800 volts) from one or more battery cell arrays that may include one or more battery cells.

The powertrain 110 may also contain at least one power electronics module 126 that is connected to the battery assembly 124 (also commonly referred to as a battery pack) and that may contain a power converter (e.g., converter, etc., as well as combinations thereof). The power electronics module 126 is typically electrically connected to the electric machines 114 and provides the ability to bi-directionally transfer electrical energy between the battery assembly 124 and the electric machines 114. For example, the battery assembly 124 may provide a DC voltage while the electric machines 114 may require a three-phase AC voltage to function. The power electronics module 126 may convert the DC voltage to a three-phase AC voltage as required by the electric machines 114. In a regenerative mode, the power electronics module 126 may convert the three-phase AC voltage from the electric machines 114 acting as generators to the DC voltage required by the battery assembly 124. The battery assembly 124 may also provide energy for other vehicle electrical systems. For example, the powertrain may employ a DC/DC converter module 128 that converts the high voltage DC output from the battery assembly 124 to a low voltage DC supply that is compatible with other vehicle loads, such as compressors and electric heaters. In a typical vehicle, the low-voltage systems are electrically connected to an auxiliary battery 130 (e.g., 12V battery). A battery energy control module (BECM) 133 may also be present that is in communication with the battery assembly 124 that acts as a controller for the battery assembly 124 and may include an electronic monitoring system that manages temperature and charge state of each of the battery cells. The battery assembly 124 may also have a temperature sensor 131, such as a thermistor or other temperature gauge. The temperature sensor 131 may be in communication with the BECM 133 to provide temperature data regarding the battery assembly 124. The temperature sensor 131 may also be located on or near the battery cells within the traction battery 124. It is also contemplated that more than one temperature sensor 131 may be used to monitor temperature of the battery cells.

In certain embodiments, the battery assembly 124 may be recharged by an external power source 136, such as an electrical outlet. The external power source 136 may be electrically connected to electric vehicle supply equipment (EVSE) that regulates and manages the transfer of electrical energy between the power source 136 and the vehicle 112. The EVSE 138 may have a charge connector 140 for plugging into a charge port 134 of the vehicle 112. The charge port 134 may be any type of port configured to transfer power from the EVSE 138 to the vehicle 112 and may be electrically connected to a charger or on-board power conversion module 132. The power conversion module 132 may condition the power supplied from the EVSE 138 to provide the proper voltage and current levels to the battery assembly 124. The power conversion module 132 may interface with the EVSE 138 to coordinate the delivery of power to the vehicle 112.

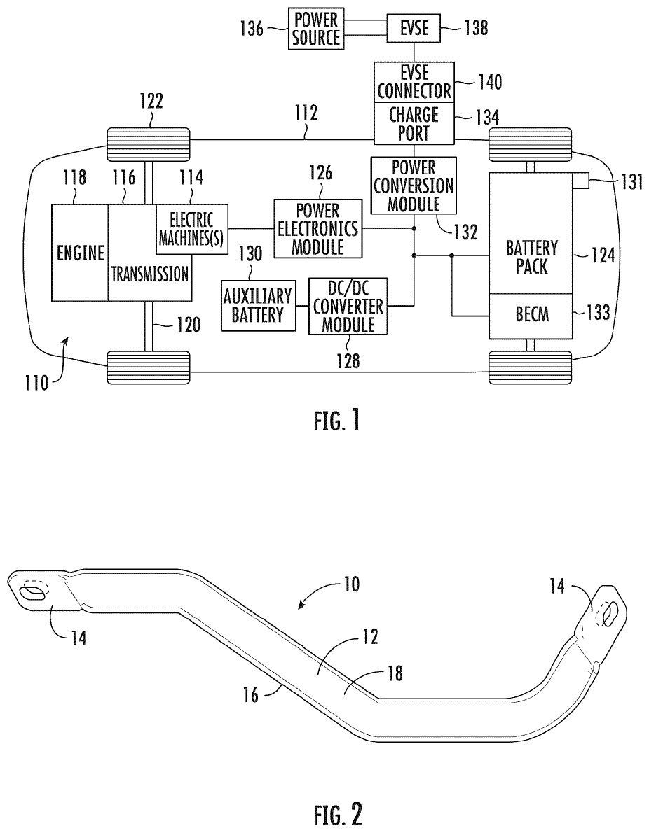

The polymer composition described herein can be included in various components of an electric vehicle as illustrated in FIG. 1. For instance, a busbar, one example of which is illustrated in FIG. 2, may be used to electrically connect individual cells of the battery assembly 124. Referring to FIG. 3, for example, the battery assembly 124 can include a number of battery cells 158. The battery cells 158 may be stacked side-by-side to construct a grouping of battery cells, sometimes referred to as a battery array. In one embodiment, the battery cells 158 are prismatic, lithium-ion cells. However, battery cells having other geometries (cylindrical, pouch, etc.) and/or chemistries (nickel-metal hydride, lead-acid, etc.) could alternatively be utilized within the scope of this disclosure. Each battery cell 158 includes a positive terminal (designated by the symbol (+)) and a negative terminal (designed by the symbol (−)). The battery cells 158 are arranged such that each battery cell 158 terminal is disposed adjacent to a terminal of an adjacent battery cell 158 having an opposite polarity. As used herein, the terms “battery”, “cell”, and “battery cell” may be used interchangeably to refer to any type of individual battery element used in a battery system. The batteries described herein typically include lithium-based batteries, but may also include various chemistries and configurations including iron phosphate, metal oxide, lithium-ion polymer, nickel metal hydride, nickel cadmium, nickel-based batteries (hydrogen, zinc, cadmium, etc.), and any other battery type compatible with an electric vehicle. For example, some embodiments may use the 6831 NCR 18650 battery cell from Panasonic®, or some variation on the 18650 form-factor of 6.5 cm×1.8 cm and approximately 45 g.

The manner in which a busbar connects to individual battery cells of a battery assembly 124, such as shown in FIG. 3, may vary as is known in the art. Referring to FIG. 2, one embodiment of a busbar 10 is shown that includes a conductive body 12. The body 12 includes a conductive material 18, such as copper, aluminum, aluminum alloy, etc., and can generally be in the form of a solid bar, hollow tube, and so forth. The busbar 10 includes a connector portion 14 at either end that is configured to mate with respective terminations of two or more batteries. An insulative portion 16 (e.g., coating or molded material) that includes the polymer composition as described herein may cover a portion of the conductive material of the body 12. To form the busbar 10, the insulative portion 16 can be applied to the surface of the conductive material 18. For instance, a bar or tube of the conductive material 18 can be inserted into a pre-formed tube of the insulating coating 16, e.g., an extruded tube sized and cut to the correct proportions, following which the busbar 10 can be shaped to any suitable form. In another embodiment, the insulating coating can be applied to the surface of the conductive material 18 in the melt, and can solidify on the surface of the conductive material in the applied areas.

Of course, a busbar may be provided in any suitable shape and size. For instance, a busbar may be used as a template for placing the individual battery cells so that they are uniform in each battery assembly manufactured. In such an embodiment, a busbar may hold individual batteries of a battery assembly 124 in place during the manufacturing process and thermal padding or injection-housings, which can be formed of a polymer composition as described herein, can be added without causing the individual battery cells to shift out of position.

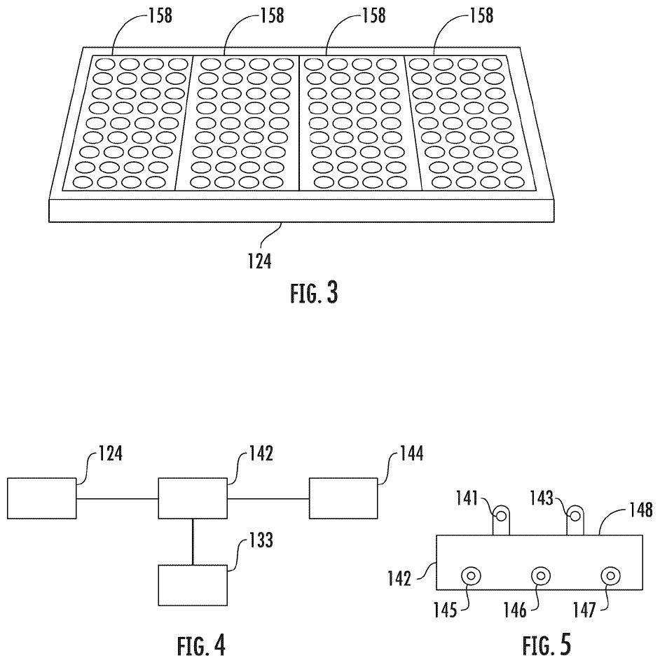

Apart from busbars, other components may also employ the polymer composition of the present invention. For instance, FIG. 4 presents a block diagram of battery electronics of an electric vehicle 112. The illustrated battery electronics system includes a battery assembly 124 and a current sensor 142. As shown, current sensor 142 is connected between battery assembly 124 and load/source 144. The current sensor 142 can be configured to measure the current flowing from the battery assembly 124 to the load/source 144 when load/source 144 is a load such as one or more electric machines 114. Likewise, current sensor 142 can be configured to measure the current flowing to battery assembly 124 from load/source 144 when the load/source 144 is a source such as an external power source 136. The (BECM) 133 can be configured to power current sensor 142 to enable its operation. The BECM 133 can further be configured to read an output generated by current sensor 142 which is indicative of the current flowing between battery assembly 124 and load/source 144.

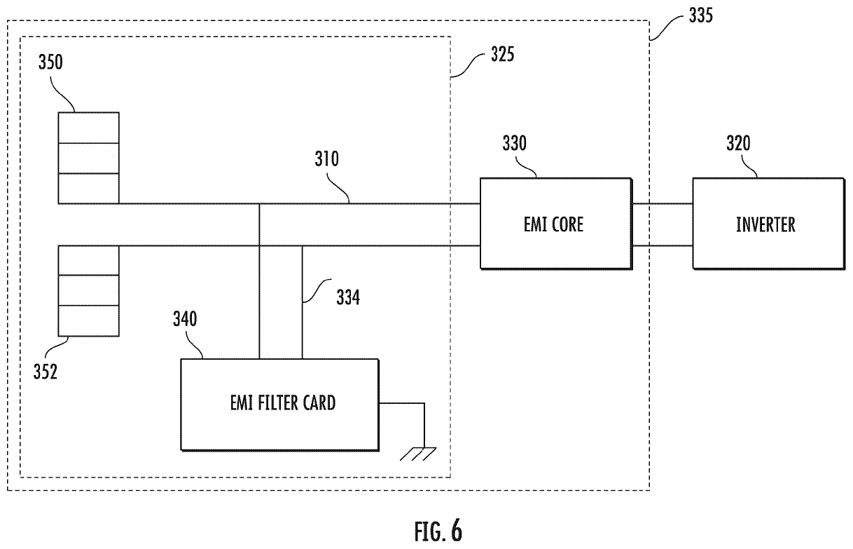

FIG. 5 illustrates one embodiment of a current sensor 142. A current sensor 142 can include a current in port 141 and a current out port 143 as well as standard ground 145, voltage at common collector (VCC) 146, and output port(s) 147. The current sensor 142 can also include a housing 148 that includes the polymer composition as described that can house other components of the current sensor 142, e.g., resistors, capacitors, converters, processing chips, etc.

Another component of an electric vehicle as may incorporate the polymer compositions as described is an inverter system, one exemplary embodiment of which is illustrated in FIG. 6. The system includes an inverter module 320 and an interconnection system 335. The interconnection system 335 includes an Electromagnetic Interference (EMI) core 330 and an EMI filter apparatus 325. The inverter module 320 is coupled to the interconnection system 335 by a pair of bus bars 310. The EMI core 330 is located between the EMI filter apparatus 325 and the inverter module 320 and is in communication with the bus bars 310. The EMI filter apparatus 325 includes an EMI filter card 340 and a pair of bolts 350, 352 which include a positive terminal (+) bolt 350 and a negative terminal (−) bolt 352 for coupling to a power source, e.g., the battery assembly 124. The EMI core 330 is coupled to the bolts 350, 352 by the bus bars 310. The EMI filter card 340 is also coupled between ground and the bus bars 310 via a pair of wires 334. An inverter module 320 includes a number of transistors (not shown). Transistors in an inverter module 320 switch on and off relatively rapidly (e.g., 5 to 20 kHz). This switching tends to generate electrical switching noise. The electrical switching noise should ideally be contained inside the inverter module 320 and prevented from entering the rest of the electrical system to prevent interference with other electrical components in the vehicle.

An inverter system can include several components that can incorporate a polymer composition as disclosed including, without limitation, the EMI filter apparatus 325, e.g., as a housing and/or internal support structures, an EMI filter card 340, the bus bars 310, as well as connectors employed within the system. For example, an electrical connector that includes the polymer composition as described herein may be employed in an inverter system as in FIG. 7 or within another portion of an electric vehicle. An electrical connector can in general include a first connector portion that contains at least one electrical contact and an insulating member that surrounds at least a portion of the connector portion. The insulating member may contain the polymer composition of the present invention. The first connector portion may be configured to mate with an opposing second connector portion that contains a receptacle for receiving the electrical contact. In such embodiments, the second connector portion may contain at least one receptacle configured to receive the electrical contact of the first connector portion and an insulating member that surrounds at least a portion of the second connector portion. The insulating member of the second connector portion may also contain the polymer composition of the present invention.

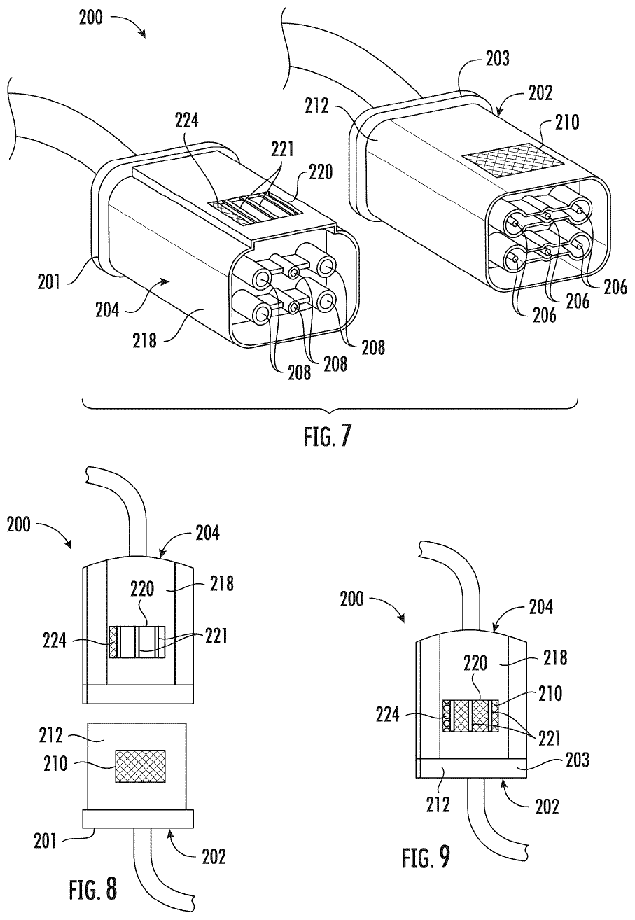

Referring to FIG. 7, FIG. 8, and FIG. 9, one particular embodiment of a connector 200 is shown for use in an electric vehicle, e.g., in an electric vehicle powertrain. The connector 200 contains a first connector portion 202 and a second connector portion 204. The first connector portion 202 may include one or more electrical pins 206 and the second connector portion 204 may include one or more receptacles 208 for receiving the electrical pins 206. A first insulator member 212 may extend from a base 203 of the first connecting portion 202 to surround the pins 206, and similarly, a second insulator member 218 may extend from a base 201 of the second connecting portion 204 to surround the receptacles 208. In certain cases, the periphery of the first insulator member 212 may extend beyond an end of the electrical pins 206 and the periphery of the second insulator member 218 may extend beyond an end of the receptacles 208. The base 203 and/or the first insulator member 212 of the first connector portion 202, as well as the base 201 and/or the second insulator member 218 of the second connector portion 204, may be formed from the polymer composition of the present invention.

Although by no means required, the first connector portion 202 may also include an identification mark 210 secured to or defined by the first protective member 212. The second connecting portion 204 may also optionally define an alignment window 220 sized according to the identification mark 210 to more easily determine when the portions are fully mated. For instance, the identification mark 210 may not be readable unless blockers 221 cover a portion of the identification mark 210. Optionally, the second connecting portion 204 may include a supplemental mark 224 located adjacent to the alignment window 220.

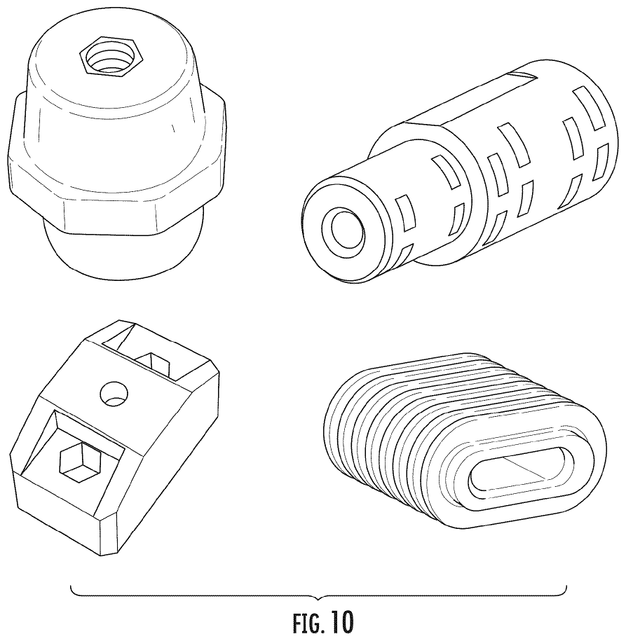

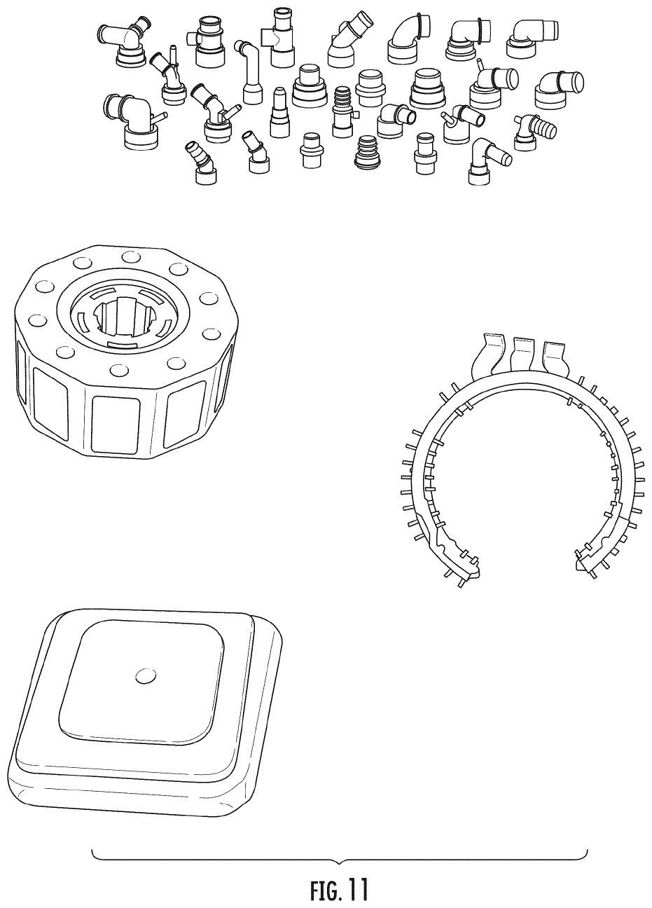

FIG. 10 and FIG. 11 illustrate yet other examples of components that may employ the polymer composition of the present invention, such as spacers, connectors, insulators and supports as shown in FIG. 10 and that can be formed from the polymer composition. Components as may incorporate a polymer composition illustrated in FIG. 11 include quick connects, tees, and interconnectors, a plurality of which are illustrated at the top of FIG. 11; brushless direct current motors (middle left of FIG. 11), e.g., sealing rings, housings, supports, etc. of a motor; guide rails (middle right of FIG. 11, also illustrating additional examples of busbars in the image); and battery sealing rings (bottom of FIG. 11).

Systems that can employ the polymer composition of the present invention are in no way limited to only electrical systems. For example, a thermal management system can also beneficially incorporate the polymer composition. A thermal management system of an electric vehicle can generally include multiple different subsystems such as, without limitation, a power train subsystem, a refrigeration subsystem, a battery cooling subsystem, and a heating, ventilation, and cooling (HVAC) subsystem. In some embodiments, one or more subsystems of a thermal management system may in fluid communication with one another, thus allowing hot heat transfer medium to flow from the high temperature circuit into the low temperature circuit, and cooler heat transfer medium to flow from the low temperature circuit into the high temperature circuit.

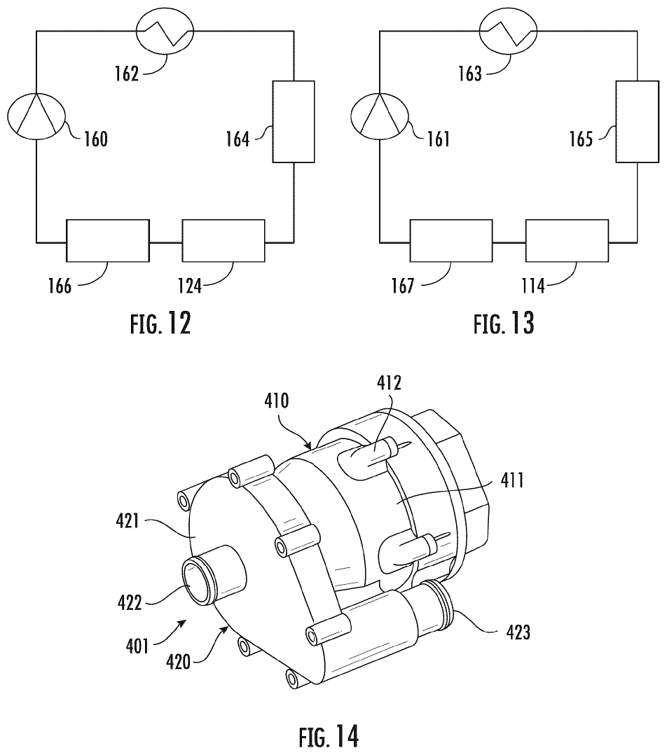

By way of example, FIG. 12 illustrates a first temperature control loop and FIG. 13 illustrates a second temperature control loop as may be found in electric vehicles, each of which designed for different subsystems and each of which including one or more components that can employ a polymer compositions of the invention. By way of example, a first temperature control loop in a typical electric vehicle (FIG. 12) can include a heat transfer medium (e.g., water) that is pumped through the loop via a suitable pump 160, e.g., an electric water pump, and cooled via heat transfer with a refrigerant in a heat exchanger 163 (e.g., an energy storage system (ESS) heat exchanger) as well as a radiator/reservoir 164. Additionally, the loop can include a heater 166 e.g., a positive temperature coefficient (PTC) heater, which can ensure that the temperature of the system can be maintained within its preferred operating range regardless of the ambient temperature, and the battery assembly 124. A second temperature control loop (FIG. 13) can also include a heat transfer medium that can be the same or differ from the heat transfer medium of another subsystem. The heat transfer medium of the second temperature control loop can be pumped through the loop with a suitable pump 161, a heat exchanger 163, and a radiator/reservoir 165. A high temperature control loop can be utilized in cooling the power electronics 167 as well as the electric machines 114 of the vehicle.

One example of a component of a heat management system that may incorporate the polymer composition of the invention is a coolant pump, e.g., an electric water pump, an example of which is illustrated in FIG. 14. As shown, the electric water pump 401 includes an electric motor 410 as a drive source and a hydraulic portion 420 for generating coolant suction and discharge forces. The motor 410 and associated components are retained with in the motor housing 411. The hydraulic portion 420 includes a volute casing 421 that generally includes a spiral flow space, an inlet 422, and outlet 423, and an impeller (not shown) rotated by the electric motor 410. The pump 401 has an interface including a mechanical seal (not shown), for sealing and separating the water flow space and the motor chamber. Generally, a mounting portion 412 is provided on the motor housing 411 to mount the pump 401 in the vehicle. Components of an electric pump 401 such as housings, casings, interfaces, etc. can incorporate a polymer composition of the invention.

The present invention may be better understood with reference to the following examples.

### Test Methods

Melt Viscosity. The melt viscosity (Pa-s) may be determined in accordance with ISO 11443:2021 at a shear rate of 400 s⁻¹ and using a Dynisco LCR7000 capillary rheometer. The rheometer orifice (die) may have a diameter of 1 mm, length of 20 mm, L/D ratio of 20.1, and an entrance angle of 180°. The diameter of the barrel may be 9.55 mm+0.007 mm and the length of the rod was 233.4 mm. The melt viscosity is typically determined at a temperature of 310° C.

Crystallization Half-Time: The crystallization half-time (minutes) is determined by differential scanning calorimetry (TA Instrument Discovery 250) in accordance with ISO 11357-7:2022. More particularly, a sample is initially equilibrated at 50° C., heated to 340° C. in nitrogen at a heating rate of 50° C. per minute, and then held at 340° C. for 10 minutes. Thereafter, the sample is cooled to an isothermal hold temperature of 245° C. in nitrogen at a cooling rate of 80° C. per minute. The sample is kept at the isothermal hold temperature of 245° C. for 60 minutes. The crystallization half-time is recorded as the time (in minutes) to reach half of the peak crystallinity.

Tensile Modulus, Tensile Stress at Break, and Tensile strain at Break: Tensile properties may be tested according to ISO 527-2/1A: 2019 (technically equivalent to ASTM D638-14). Modulus and strength measurements may be made on the same test strip sample having a length of 80 mm, thickness of 10 mm, and width of 4 mm. The testing temperature may be 23° C., and the testing speeds may be 5 mm/min.

Flexural Modulus, Flexural Stress at Break, and Flexural Stress: Flexural properties may be tested according to ISO 178:2019 (technically equivalent to ASTM D790-10). This test may be performed on a 64 mm support span. Tests may be run on the center portions of uncut ISO 3167 multi-purpose bars. The testing temperature may be 23° C. and the testing speed may be 2 mm/min.

Charpy Impact Strength: Charpy properties may be tested according to ISO 179-1:2010) (technically equivalent to ASTM D256-10, Method B). This test may be run using a Type 1 specimen size (length of 80 mm, width of 10 mm, and thickness of 4 mm). When testing the notched impact strength, the notch may be a Type A notch (0.25 mm base radius). Specimens may be cut from the center of a multi-purpose bar using a single tooth milling machine. The testing temperature may be 23° C.

Laser Transmission Rate: The laser transmission rate may be determined using LPKF TMG 3 measuring device at a wavelength of 980 nm. The test plaque typically has a thickness of 1 mm.

### Comparative Examples 1-2

Comparative Examples 1-2 are melt mixed using a 32 mm Coperion co-rotating, fully-intermeshing, twin-screw extruder and include various concentrations of a polyarylene sulfide, glass fibers, aminosilane, and lubricant. The glass fibers are chopped glass strand fibers having a circular diameter. The formulations are set forth in more detail in the table below.

| | Comp. Ex. 1 | Comp. Ex. 2 |
|---|---|---|
| | (wt. %) | (wt. %) |
| PPS | 79.3 | 69.3 |
| Aminosilane | 0.4 | 0.4 |
| Glass Fibers | 20 | 30 |
| Lubricant | 0.3 | 0.3 |

Once formed, the resulting composition was then injected molded and tested for various properties as described above. The results are set forth below.

| | Comp. Ex. 1 | Comp. Ex. 2 |
|---|---|---|
| Tensile Modulus (MPa) | 8,548 | 12,000 |
| Tensile Strength (MPa) | 133 | 170 |
| Tensile Break Strain (%) | 1.9 | 1.9 |
| Flexural Modulus (MPa) | 8,000 | 11,000 |
| Flexural Strength (MPa) | 170 | 260 |
| Charpy Notched at 23° C. (kJ/m²) | 7 | 9 |
| Laser Transmission at 1 mm (%) | 13.2 | 9.7 |

### Comparative Examples 3-4

Comparative Examples 3-4 are melt mixed using a 32 mm Coperion co-rotating, fully-intermeshing, twin-screw extruder and include various concentrations of a polyarylene sulfide (PPS 1), glass fibers, aminosilane (3-aminopropyl-triethoxysilane), and an antioxidant. PPS 1 has a melt flow index of about 500 g/10 minutes. The glass fibers are chopped glass strands having an aspect ratio (ratio of width to thickness) of 4. The antioxidant is bis(2,4-ditert-butylphenyl) pentaerythritol bisdiphosphite. The formulations are set forth in more detail in the table below.

| | Comp. Ex. 3 | Comp. Ex. |
|---|---|---|
| | (wt. %) | (wt. %) |
| PPS 1 | 69.6 | 69.2 |
| Glass Fibers | 30 | 30 |
| Aminosilane | 0.4 | 0.4 |
| Antioxidant | — | 0.1 |

Once formed, the resulting composition was then injected molded and tested for various properties as described above. The results are set forth below.

| | Comp. Ex. 3 | Comp. Ex. 4 |
|---|---|---|
| Tensile Modulus (MPa) | 11,749 | — |
| Tensile Strength (MPa) | 165 | — |
| Tensile Break Strain (%) | 1.7 | — |
| Flexural Modulus (MPa) | 11,768 | — |
| Flexural Strength (MPa) | 259 | — |
| Charpy Notched at 23° C. (kJ/m²) | 11.6 | — |
| Melt Viscosity T5 at | 297.5 | 353.7 |
| 400 s⁻¹ (Pa-s) | | |
| Laser Transmission at 1 mm (%) | 13.1 | 13.1 |
| Crystallization Half-Time | 8.2 | 5.9 |
| at 245° C. (minutes) | | |

### Examples 1-6

Examples 1-6 are melt mixed using a 32 mm Coperion co-rotating, fully-intermeshing, twin-screw extruder and include various concentrations of a polyarylene sulfide (PPS 1), glass fibers, aminosilane (3-aminopropyl-triethoxysilane), and an antioxidant. The glass fibers are chopped glass strands having an aspect ratio (ratio of width to thickness) of 4. The antioxidant is bis(2,4-ditert-butylphenyl) pentaerythritol bisdiphosphite. The formulations are set forth in more detail in the table below.

| | Ex. 1 | Ex. 2 | Ex. 3 | Ex. 4 | Ex. 5 | Ex. 6 |
|---|---|---|---|---|---|---|
| | (wt. %) | (wt. %) | (wt. %) | (wt. %) | (wt. %) | (wt. %) |
| PPS 1 | 69.1 | 69.0 | 68.8 | 69.1 | 68.6 | 68.1 |
| Glass Fibers | 30 | 30 | 30 | 30 | 30 | 30 |
| Aminosilane | 0.4 | 0.4 | 0.4 | 0.4 | 0.4 | 0.4 |
| Antioxidant | 0.2 | 0.3 | 0.5 | 0.5 | 1 | 1.5 |

Once formed, the resulting composition was then injected molded and tested for various properties as described above. The results are set forth below.

| | Ex. 1 | Ex. 2 | Ex. 3 | Ex. 4 | Ex. 5 | Ex. 6 |
|---|---|---|---|---|---|---|
| Tensile Modulus (MPa) | — | — | — | 11,986 | 12,036 | 12,044 |
| Tensile Strength (MPa) | — | — | — | 165 | 168 | 173 |
| Tensile Break Strain (%) | — | — | — | 1.7 | 1.7 | 1.7 |
| Flexural Modulus (MPa) | — | — | — | 11,924 | 12,260 | 12,102 |
| Flexural Strength (MPa) | — | — | — | 260 | 266 | 261 |
| Charpy Notched at 23° C. (kJ/m²) | — | — | — | 12.1 | 12.7 | 13.0 |
| Melt Viscosity T5 at 400 s⁻¹ (Pa-s) | 322.8 | 324.9 | 294.6 | 376.8 | 403.6 | 421.8 |
| Laser Transmission at 1 mm (%) | 13.2 | 13.5 | 13.5 | 13.9 | 14.0 | 14.2 |
| Crystallization Half-Time at 245° C. (minutes) | 8.8 | 12.1 | 13.5 | 17.0 | 17.2 | 16.8 |

### Examples 7-8

Examples 7-8 are melt mixed using a 32 mm Coperion co-rotating, fully-intermeshing, twin-screw extruder and include various concentrations of PPS 1, glass fibers, lubricant (Glycolube™ P), aminosilane (3-aminopropyl-triethoxysilane), and an antioxidant. The glass fibers are chopped glass strands having an aspect ratio (ratio of width to thickness) of 4. The antioxidant is bis(2,4-ditert-butylphenyl) pentaerythritol bisdiphosphite. The formulations are set forth in more detail in the table below.

| | Ex. 7 | Ex. 8 |
|---|---|---|
| | (wt. %) | (wt. %) |
| PPS 1 | 68.3 | 64.6 |
| Glass Fibers | 30 | 30 |
| Aminosilane | 0.4 | 0.4 |
| Antioxidant | 1 | 1 |
| Lubricant | 0.3 | 0.3 |
| Laser Transmissive Black Colorant | — | 4 |

Once formed, the resulting composition was then injected molded and tested for various properties as described above. The results are set forth below.

| | Ex. 7 | Ex. 8 |
|---|---|---|
| Tensile Modulus (MPa) | 12,036 | 12,044 |
| Tensile Strength (MPa) | 168 | 167 |
| Tensile Break Strain (%) | 1.7 | 1.7 |
| Flexural Modulus (MPa) | 12,260 | 12,441 |
| Flexural Strength (MPa) | 266 | 275 |
| Charpy Notched at 23° C. (kJ/m²) | 12.7 | 12.9 |
| Melt Viscosity T5 at 400 s⁻¹ (Pa-s) | 394.9 | 474.7 |
| Laser Transmission at 1 mm (%) | 14.1 | 13.9 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A laser transmissive polymer composition comprising 100 parts by weight of a polymer matrix that contains a polyarylene sulfide, from about 10 parts by weight to about 80 parts by weight of inorganic fibers having an aspect ratio of from about 1.5 to about 10, and from about 0.15 parts to about 2.5 parts by weight of antioxidants, wherein the polymer composition exhibits a crystallization half-time of about 8.5 minutes or more as determined by differential scanning calorimetry at an isothermal hold temperature of 245° C. in accordance with ISO 11357-7:2022.

2. The laser transmissive polymer composition of claim 1, wherein the polymer composition includes a phosphite antioxidant.

3. The laser transmissive polymer composition of claim 2, wherein the phosphite antioxidant includes an aryl diphosphite having the following general structure (I): 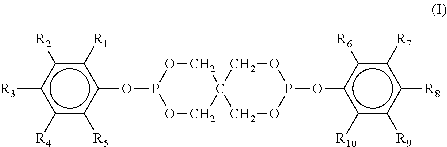
wherein,
R₁, R₂, R₃, R₄, R₅, R₆, R₇, R₈, R₉, and R₁₀ are independently selected from hydrogen, C₁ to C₁₀ alkyl, and C₃ to C₃₀ branched alkyl.

4. The laser transmissive polymer composition of claim 1, wherein the polymer matrix constitutes from about 40 wt. % to about 85 wt. % of the polymer composition.

5. The laser transmissive polymer composition of claim 1, wherein the polyarylene sulfide is a polyphenylene sulfide.

6. The laser transmissive polymer composition of claim 5, wherein the polyarylene sulfide is a linear polyphenylene sulfide.

7. The laser transmissive polymer composition of claim 1, wherein the inorganic fibers have a width of from about 1 to about 50 micrometers and a thickness of from about 0.5 to about 30 micrometers.

8. The laser transmissive polymer composition of claim 1, wherein the inorganic fibers include glass fibers.

9. The laser transmissive polymer composition of claim 1, wherein the inorganic fibers are coated with a sizing composition.

10. The laser transmissive polymer composition of claim 9, wherein the sizing composition contains an alkoxysilane.

11. The laser transmissive polymer composition of claim 1, wherein the inorganic fibers have an index of refraction of from about 1.55 to about 2 as determined at a wavelength of 590 nm.

12. The laser transmissive polymer composition of claim 1, further comprising from about 0.1 to about 3 parts by weight of an organosilane compound.

13. The laser transmissive polymer composition of claim 1, wherein the polymer composition exhibits a laser transmission rate of from about 10% to about 40% % as determined at a thickness of 1 mm and wavelength of 980 nm.

14. The laser transmissive polymer composition of claim 1, wherein the polymer matrix exhibits a melt flow index of greater than about 250 grams per 10 minutes as determined in accordance with ASTM D1238-13 at a load of 2.16 kg and temperature of 190° C.

15. A composite structure comprising a first polymer component that is laser welded to a second polymer component at a polymer-polymer interface, wherein the first polymer component includes the polymer composition of claim 1.

16. The composite structure of claim 15, wherein the second polymer component exhibits a laser transmission rate lower than the first polymer component.

17. The composite structure of claim 15, wherein the polymer composition of the first component exhibits a melting temperature of from about 250° C. to about 320° C.

18. The composite structure of claim 17, wherein the polymer composition used to form the second polymer component exhibits a melting temperature of from about 200° C. to about 300° C.

19. A method of joining a first polymer component to a second polymer component, the method comprising contacting a first polymer component and a second polymer component to form an interface, wherein the first polymer component comprises the polymer composition of claim 1, and passing a light beam through a portion of the first polymer component to form a laser weld joint at the interface.
